(19) United States
(12) Patent Application Publication
(10) Pub. No.: US 2011/0199356 A1
(43) Pub. Date: Aug. 18, 2011

(54) PIXEL CIRCUIT AND DISPLAY PANEL

(75) Inventors: Hideo Ochi, Fucyu (JP); Satoru Ohta, Saitama (JP); Akira Hirasawa, Saitama (JP); Kenji Nakamura, Saitama (JP); Takahito Oyamada, Machida (JP)

(73) Assignee: PIONEER CORPORATION, Tokyo (JP)

(21) Appl. No.: 12/742,547

(22) PCT Filed: Jun. 12, 2007
(86) PCT No.: PCT/JP2007/073587

§ 371 Date: Oct. 20, 2010

(51) Int. Cl. G06F 3/038

(52) U.S. Cl. 345/211

(57) ABSTRACT

A pixel circuit includes a first power line that supplies a first power, a single control line, an emission control variable resistance element having one end connected to the first power line and the other end connected to the control line, a second power line that supplies a second power, a light-emitting element that has one end connected to the control line and the other end connected to the second power line and emits light in accordance with data written to the emission control variable resistance element, and a parallel connection variable resistance element having one end connected to the control line and the other end connected to the second power line so that it is parallel with the light-emitting element.

### CROSS-REFERENCE TO RELATED APPLICATION

This is an application PCT/JP2007/073587, filed Dec. 6, 2007, which was not published under PCT article 21(2) in English.

### BACKGROUND OF THE INVENTION

1. Field of the Invention

The present invention relates to a pixel circuit and display panel wherein a light-emitting element emits light based on data written to an emission control variable resistance element.

2. Description of the Related Art

In the display panels of recent years, memory cells equivalent to pixel circuits are formed in regions where word lines and bit lines intersect. Each memory cell is arranged in a matrix shape along these word lines and bit lines, resulting in a structure in which the word lines, semiconductor layers, memory layers, and bit lines are connected in series. This memory cell functions as a switching memory composite element.

According to a display panel of prior art, the controller writes data to each memory layer based on control signals, and performs delete operations and reset all operations on the data written to each memory layer. Examples of such data include emission and non-emission instructions for the light-emitting layer. Furthermore, according to the display panel of prior art, each memory cell controls the conductivity of the semiconductor layer based on the data written to the memory layer, causing the display panel to display an image corresponding to the light-emitting status of each memory cell.

Patent Document 1: JP, A, 16-47791 (paragraph number 0010, FIG. 3)

### SUMMARY OF THE INVENTION

### Problem to be Solved by the Invention

According to the above-described display panel of prior art, even in a case where non-emission instruction data are written to the memory layer of each memory cell to change the light-emitting layer to a non-light-emitting state, a slight amount of current sometimes actually flows between the word lines and bit lines, causing the light-emitting layer to output a slight amount of light, resulting in unfavorable contrast.

The above-described problem is given as an example of the problems that are to be solved by the present invention.

### Means of Solving the Problem

In order to achieve the above-mentioned ovbject, according to the first invention, there is provided a pixel circuit comprising: a first power line that supplies a first power; a single control line; an emission control variable resistance element having one end connected to the first power line and another end connected to the control line; a second power line that supplies a second power; a light-emitting element having one end connected to the control line and another end connected to the second power line, that emits light in accordance with data written to the emission control variable resistance element; and a parallel connection variable resistance element having one end connected to the control line and another end connected to the second power line so that it is parallel with the light-emitting element.

In order to achieve the above-mentioned ovbject, according to the 12th invention, there is provided a display panel arranging at least a pixel circuit, the pixel circuit comprising: a first power line that supplies a first power; a single control line; an emission control variable resistance element having one end connected to the first power line and another end connected to the control line; a second power line that supplies a second power; a light-emitting element having one end connected to the control line and another end connected to the second power line, that emits light in accordance with data written to the emission control variable resistance element; and a parallel connection variable resistance element having one end connected to the control line and another end connected to the second power line so that it is parallel with the light-emitting element.

### BRIEF DESCRIPTION OF THE DRAWINGS

FIG. 1 is a block diagram illustrating an example of the electrical configuration of the display panel of the embodiment.

FIG. 2 is an equivalent circuit diagram illustrating a configuration example of each of the pixel circuits included in the pixel array circuit of FIG. 1.

FIG. 3 shows a hysteresis loop characteristics diagram illustrating an example of the current-voltage characteristics corresponding to the state of the parallel connection variable resistance element.

FIG. 4 shows a hysteresis loop characteristics diagram illustrating an example of the current-voltage characteristics corresponding to the state of the emission control variable resistance element.

FIG. 5 is a diagram illustrating an example of voltage control of each signal line for performing data writing.

FIG. 6 is a diagram illustrating an example of the verification results related to the characteristics of the light-emitting element.

FIG. 7 is a diagram illustrating a configuration example of a general pixel circuit. FIG. 8 is a current-voltage characteristics diagram of the light-emitting element in a case where the emission control variable resistance element 5 of the pixel circuit of FIG. 7 takes on various resistance values.

FIG. 9 illustrates an example of current-voltage characteristics for comparing the current that flows on the side of the light-emitting element of the pixel circuit of FIG. 2.

FIG. 10 is a current-voltage characteristics diagram illustrating an example of the current that flows to the light-emitting element and the parallel connection variable resistance element connected in parallel to one another.

FIG. 11 is a current-voltage characteristics diagram illustrating an example of the current that flows to the light-emitting element and the parallel connection variable resistance element connected in parallel to one another.

FIG. 12 is a diagram showing an example of the hysteresis loop characteristics of the parallel connection variable resistance element of the pixel circuit of another embodiment.

FIG. 13 is a diagram illustrating an example of voltage control of each signal line for performing data writing.

FIG. 14 is an equivalent circuit diagram illustrating a configuration example of the pixel circuit of a modification of each embodiment.

### DETAILED DESCRIPTION OF THE PREFERRED EMBODIMENTS

The following describes an embodiment of the present invention with reference to accompanying drawings.

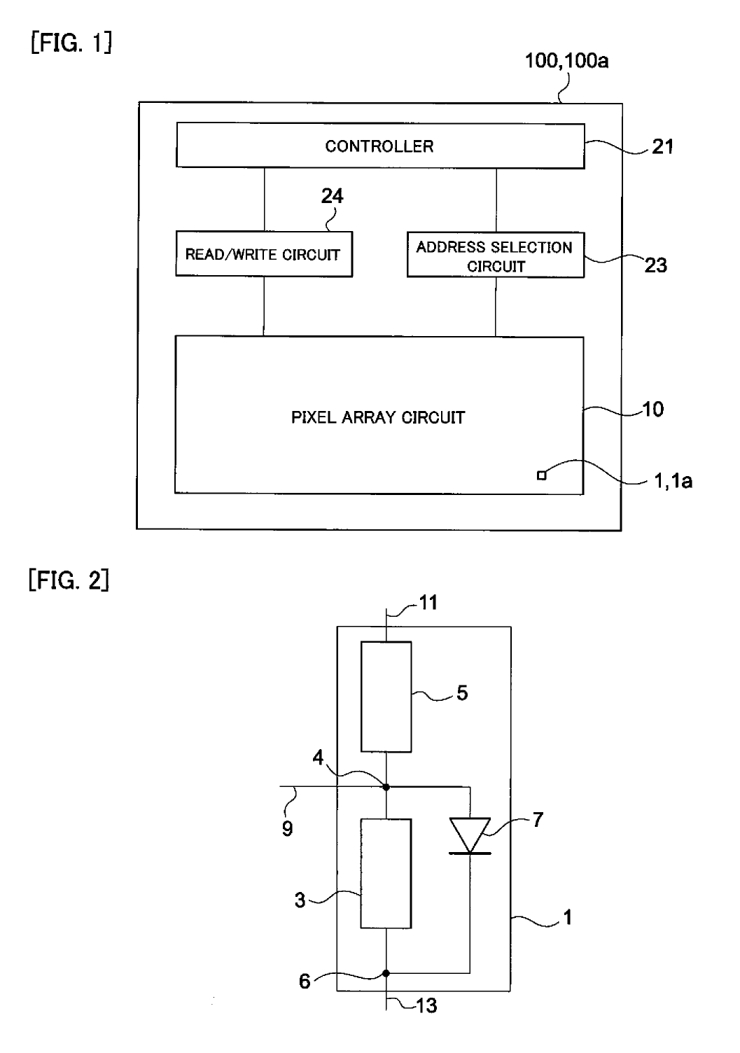

FIG. 1 is a block diagram illustrating an example of the electrical configuration of a display panel 100 of the embodiment.

The display panel 100 comprises a controller 21, a read/write control circuit (hereinafter simply “read/write circuit”) 24, an address selection circuit 23, and a pixel array circuit 10. Note that the display panel 100 may also include circuits and peripheral circuits (not shown) for an error correction circuit, refresh circuit, buffer circuit, and the like.

The controller 21 is capable of reading and writing data with the pixel array circuit 10 using the address selection circuit 23 and the read/write circuit 24, based on external control signals or internal control signals. Examples of such data include emission instructions (equivalent to “white writing” hereinafter) and non-emission instructions (equivalent to “black writing” hereinafter) for making each light-emitting element of the pixel circuit 1 arranged on the pixel array circuit 10 emit light or not emit light, respectively. Additionally, the controller 21 performs delete operations and reset all operations on the data written to each of the pixel circuits 1.

The pixel array circuit 10 contains a plurality of the pixel circuits 1 formed into a matrix-shaped memory array, for example, and each of the pixel circuits 1 is connected by bit lines and word lines. Each of the pixel circuits 1 uses so-called variable resistance memory. Here, variable resistance memory is equivalent to the variable resistance element described later. The element array circuit 10 will be described later.

The address selection circuit 23 has a function of specifying bit lines and word lines based on an address specification signal supplied from the controller 21, and selecting the preferred pixel circuit 1 from the group of pixel circuits 1 arranged on the pixel array circuit 10.

The read/write circuit 24 is capable of reading and writing data with the pixel array circuit 10 based on a write control signal or read control signal supplied from the controller 21.

FIG. 2 is an equivalent circuit illustrating a configuration example of each of the pixel circuits 1 included in the pixel array circuit 10 of FIG. 1.

Each of the pixel circuits 1 comprises a first power line 11, a control line 9, a second power line 13, a light-emitting element 7, an emission control variable resistance element 5, and a parallel connection variable resistance element 3.

The first power line 11 is connected to the bit line of the pixel array circuit 10, for example, and supplies a first power from this bit line. The second power line 13 is connected to a word line, for example, and supplies a second power from this word line.

The control line 9 is connected to the above-described controller 21, and comprises one signal line for inputting a predetermined control signal to a node 4. This control line 9 is capable of changing the resistance value of the emission control variable resistance element 5 in accordance with the difference in potential produced with the first power line 11. On the other hand, this control line 9 changes the resistance value of the parallel connection variable resistance element 3 in accordance with the difference in potential produced with the second power line 13.

Here, the control line 9 is a single signal line and can therefore simultaneously change the respective resistance values of the emission control variable resistance element 5 and the parallel connection variable resistance element 3 in accordance with the potential of the first power line 11 and the potential of the second power line 13. Note that, according to the embodiment, the ratio between the resistance value of the changed emission control variable resistance element 5 and the resistance value of the parallel connection variable resistance element 3 is called the “resistance change rate.”

The emission control variable resistance element 5 is a two-terminal type variable resistance element, for example, having one end connected to the first power line 11 and the other end connected to the control line 9. The emission control variable resistance element 5 is characterized in that the resistance state changes when the difference in potential is greater than the difference in potential exerted against the light-emitting element 7 during light emission. The emission control variable resistance element 5 is a bipolar type variable resistance element, for example, and has a memory function that stores the above-described data. The emission control variable resistance element 5 is an element in which the resistance value changes in accordance with predetermined hysteresis loop characteristics when the voltage applied between the first power line 11 connected to the bit line and the node 4 (hereinafter “common node”) reaches a predetermined voltage.

The light-emitting element 7 is connected to the control line 9 on one end, and the second power line 13 on the other end. The light-emitting element 7 is an organic electroluminescent element, for example.

The parallel connection variable resistance element 3 is a two-terminal type variable resistance element having one end connected to the control line 9 and the other end connected to the second power line 13 so that it is parallel with the light-emitting element 7. The parallel connection variable resistance element 3 is characterized in that the resistance state changes when the difference in potential is greater than the difference in potential exerted against the light-emitting element 7 during light emission. The parallel connection variable resistance element 3 is a bipolar variable resistance element, for example.

The parallel connection variable resistance element 3 is an element in which the resistance value changes in accordance with the hysteresis loop characteristics as described later, in accordance with the difference in potential between the node 4 and the second power line 13 connected to the word line, for example. This parallel connection variable resistance element 3 has hysteresis loop characteristics of reverse polarity, as described later, with the above-described emission control variable resistance element 5, in accordance with the voltage with the control line 9 and the second power line 13.

In the pixel circuit 1, when light emission by the light-emitting element 7 is desired (hereinafter also referred to as a “white display”), the emission control variable resistance element 5 is set to a low resistance state, and the parallel connection variable resistance element 3 is set to a high resistance state.

On the other hand, in the pixel circuit 1, when non-emission by the light-emitting element 7 is desired (hereinafter also referred to as a “black display”), the emission control variable resistance element 5 is set to a high resistance state, and the parallel connection variable resistance element 3 is set to a low resistance state.

The emission control variable resistance element 5 and the parallel connection variable resistance element 3 each change the voltage applied to both ends of the variable resistance elements 5 and 3 according to the difference in potential between the two power lines (the first power line 11 and the second power line 13) and the control line 9, thereby making it possible to change the resistance state, i.e., to a low resistance state or a high resistance state. Here, the difference between the resistance values of the emission control variable resistance element 5 and the parallel connection variable resistance element 3 that are respectively in a low resistance state and a high resistance state is a multiplication factor of about 10 to 100, for example.

The emission control variable resistance element 5 and the parallel connection variable resistance element 3 each have a non-volatile memory function, for example. As a result, the pixel circuit 1 of the embodiment is capable of completing the preparations required before the pixel circuit 1 begins emitting light more quickly that in a configuration that employs an active matrix of prior art, even in a case where the power goes down and is subsequently turned on again.

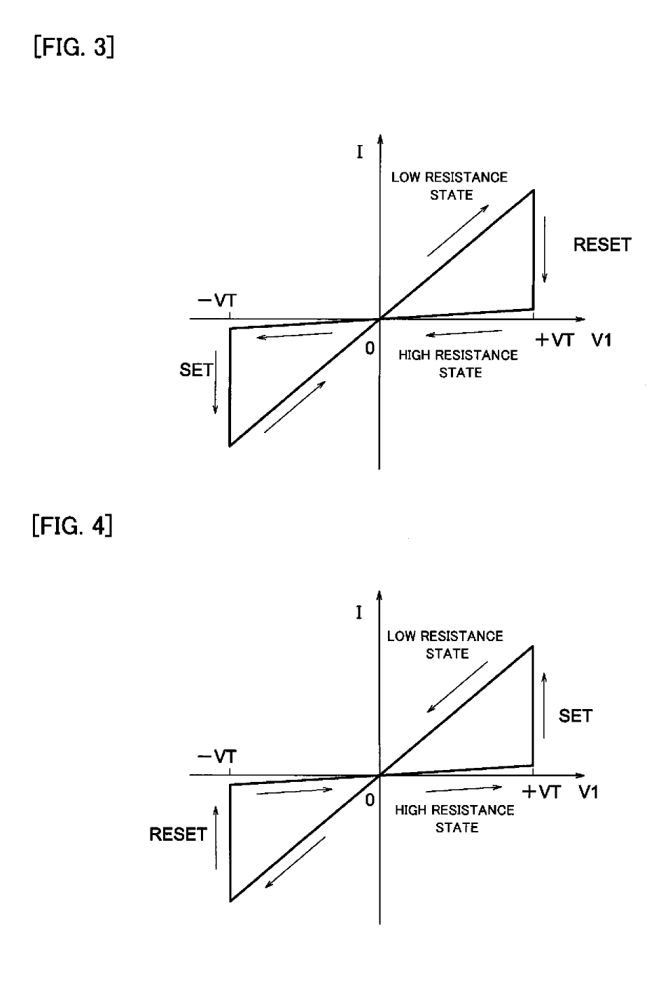

FIG. 3 shows hysteresis loop characteristics illustrating an example of the current-voltage characteristics corresponding to the state of the parallel connection variable resistance element 3.

The parallel connection variable resistance element 3 transitions from a high resistance state to a low resistance state (equivalent to “SET” in the figure) at transition voltage −VT when voltage V1 is applied in one direction, and back from a low resistance state to a high resistance state (equivalent to “RESET” in the figure) at transition voltage +VT when voltage V1 is applied in the opposite direction. The response speed of the parallel connection variable resistance element 3 is a high speed of 100 ns, for example.

According to the embodiment, the transition of each variable resistance element 3 and 5 from a high resistance state to a low resistance state is expressed as “SET,” and the transition of each variable resistance element 3 and 5 from a low resistance state to a high resistance state is expressed as “RESET.”

FIG. 4 shows hysteresis loop characteristics illustrating an example of the current-voltage characteristics corresponding to the state of the emission control variable resistance element 5.

The emission control variable resistance element 5 applies voltage of a polarity opposite the above-described parallel connection variable resistance element 3, resulting in current-voltage characteristics of a polarity opposite the above-described parallel connection variable resistance element 3.

That is, the emission control variable resistance element 5 transitions from a high resistance state to a low resistance state (equivalent to “SET” in the figure) at transition voltage +VT when voltage V1 is applied in one direction, and back from a low resistance state to a high resistance state (equivalent to “RESET” in the figure) at transition voltage −VT when voltage V1 is applied in the opposite direction. The response speed of the emission control variable resistance element 5 is a high speed of 100 ns, for example.

Here, according to the embodiment, the bias direction in which the light-emitting element 7 emits light is the same as the bias direction in which the parallel connection variable resistance element 5 is changed from a low resistance state to a high resistance state. Note that, in this embodiment, such a transition of the resistance value of the parallel connection variable resistance element 3 from a low resistance state to a high resistance state is called “RESET.”

Methods that can be employed as a manufacturing method of at least one of the emission control variable resistance element 5 and the parallel connection variable resistance element 3 described above include the manufacturing methods described in JP, A, 18-222428 and JP, A, 17-120421.

The display panel 100 comprising each of the pixel elements 1 has a configuration such as described above, and an operation example will now be described based on this configuration with reference to FIG. 1 to FIG. 4.

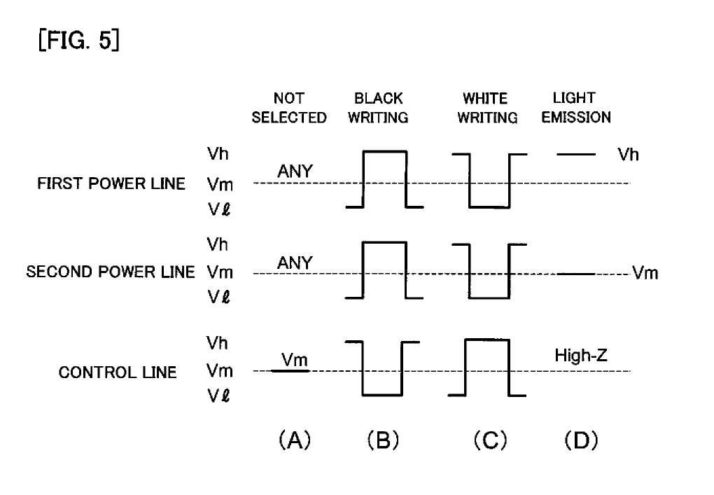

FIG. 5A to FIG. 5D each illustrate a voltage control example of each signal line for data writing. In the pixel array circuit 10, display operations are performed according to three operations, such as follows. That is, in the pixel array circuit 10, first each of the pixel circuits 1 is either selected or not selected, second data writing is performed, and third an emission operation or non-emission operation is performed.

### Selection/Non-Selection

In the pixel circuit 1, the above-described address selection circuit 23 sets the desired control line 9 to a potential in the middle of the control voltage range of the first power line 11 and the second power line 13, making the line a non-selected line.

Here, according to the embodiment, data writing for making the light-emitting element 7 emit light is expressed as “white writing,” and data writing for making the light-emitting element 7 not emit light is expressed as “black writing.” Furthermore, according to the embodiment, the read/write circuit 24 initially writes data to set a high resistance state, according to the control of the controller 21. With this arrangement, it is possible to prevent through-current from traveling from the emission control variable resistance terminal 5 to the parallel connection variable resistance element 3.

The emission control variable resistance element 5 performs black writing and white writing when the difference in potential produced between the first power line 11 and the control line 9 is oscillated as illustrated in FIG. 5B and FIG. 5C, respectively.

On the other hand, the parallel connection variable resistance element 3 also writes data (black writing or white writing) when the difference in potential produced between the second power line 13 and the control line 9 is oscillated as illustrated in FIG. 5B or FIG. 5C.

The acceptable conditions of the voltage V1 to be applied to both ends of the emission control variable resistance element 5 and the parallel connection variable resistance element 3 are as follows. Note that “ABS (value)” in equation (1) indicates the absolute value of the value in parentheses.

ABS (Vh-Vl)>ABS (RESET or SET)>ABS (Vm-Vl) or ABS (Vh-Vm)>Emission voltage of light-emitting element 7 (1)

FIG. 5A illustrates the voltage of the first power line 11, the second power line 13, and the control line 9 in a case where a certain pixel circuit 1 is not selected.

### Non-Selection

To set the pixel circuit 1 to a non-selected state, the potential of the first power line 11 and the second power line 13 may be any value, but the controller 21 must set the potential of the control line 9 to an intermediate voltage M within the voltage control range of the first power line 11 and the second power line 13. This intermediate potential Vm is expressed as the intermediate potential between high potential Vh and low potential V1.

### Selection and Black Writing

To select the pixel circuit 1 to perform black writing, the first power line 11 and the second power line 13 must each be set to the high potential Vh, and the control line 9 must be set to the low potential V1, as illustrated in FIG. 5B.

### Selection and White Writing

To select the pixel circuit 1 to perform white writing, the first power line 11 and the second power line 13 must each be set to the low potential Vl, and the control line 9 must be set to the high potential Vh, as illustrated in FIG. 5C.

### Emission/Non-Emission

To make the light-emitting element 7 of the pixel circuit 1 emit light or not emit light, the first power line 11 must be set to the high potential Vh, the second power line 13 must be set to the intermediate potential Vm, and the control line 9 must be set to a high impedance state (equivalent to High-Z in the figure), as illustrated in FIG. 5D. In this case, the light-emitting element 7 emits light when white writing is performed on the emission control variable resistance element 5, and does not emit light when black writing is performed on the emission control variable resistance element 5.

According to the embodiment, the resistance value of the parallel connection variable resistance element 3 is lower than that of the light-emitting element 7 when control for not emitting light is performed, and the resistance value of the light-emitting element 7 is lower than that of the parallel connection variable resistance element 3 and greater than that of the emission control variable resistance element 5 when control for emitting light is performed.

### Verification Related to Light-Emitting Element Characteristics

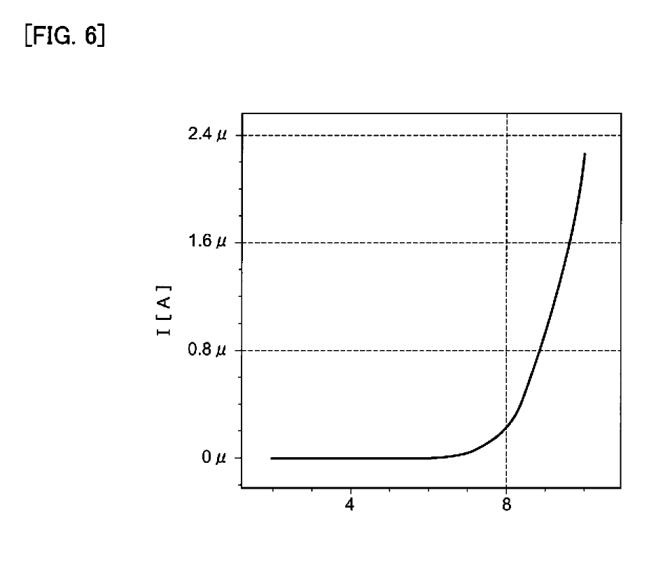

FIG. 6 is a diagram illustrating an example of the verification results related to the characteristics of the light-emitting element 7. In this example, the horizontal axis indicates applied voltage V1 [V], and the vertical axis indicates current I [A].

According to this verification example, the light-emitting element 7 is presumably an organic electroluminescent element, for example, and therefore indicates diode characteristics. According to the characteristics of this light-emitting element, the current I abruptly rises when the applied voltage V1 rises from about 7 [V] to about 9 [V].

### General Pixel Circuit

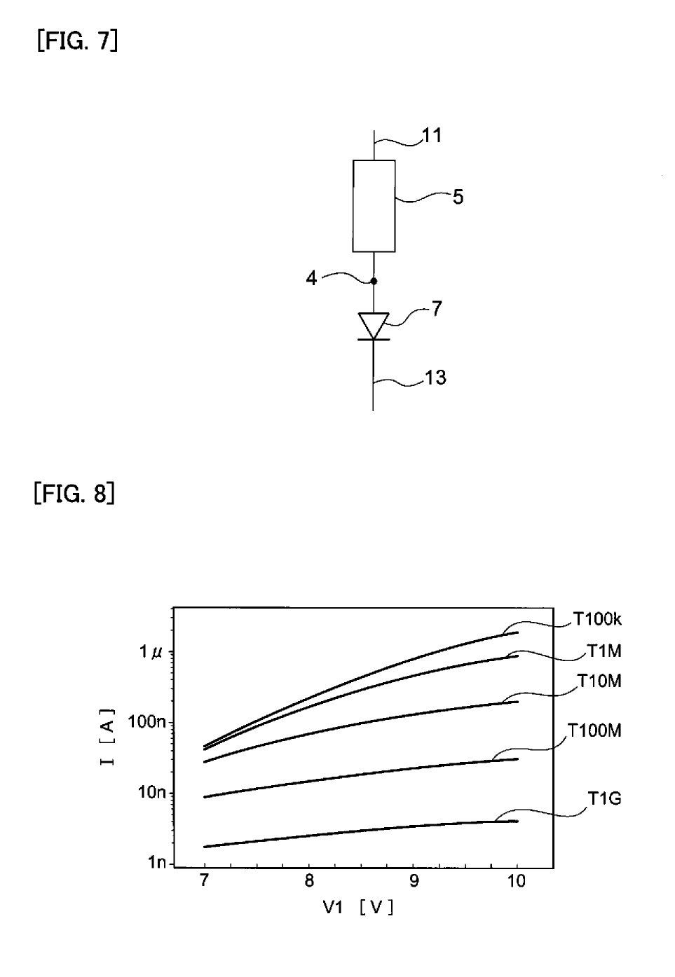

FIG. 7 is a diagram illustrating a configuration example of a general pixel circuit. Note that each block in FIG. 7 that is denoted by the same reference numeral as FIG. 2 has substantially the same configuration as FIG. 2, and descriptions thereof will be omitted.

In the general pixel circuit 1, the emission control variable resistance element 5 and the light-emitting element 7 are connected in series on the node 4 between the first power line 11 and the second power line 13. The light-emitting element 7 of this general pixel circuit emits light and does not emit light in accordance with the change in the resistance value of the emission control variable resistance element 5. Here, in the emission control variable resistance element 5 itself, the minimum resistance value and the maximum resistance value vary only by a multiplication factor of about 100, for example, resulting in a slight current flow to the light-emitting element 7 during periods of non-emission as well. This general pixel circuit 1 exhibits current-voltage characteristics such as follows.

### Current-Voltage Characteristics of General Pixel Circuit

FIG. 8 is a current-voltage characteristics diagram illustrating an example of the voltage that occurs in response to the current that flows in the light-emitting element 7 in a case where the emission control variable resistance element 5 of the pixel circuit of FIG. 7 takes on various resistance values. Note that the vertical axis indicates current [A] and the horizontal axis indicates voltage [V]. According to the example in the figure, the voltage of the first power line 11 is indicated on the horizontal axis. The second power line 13 is grounded.

FIG. 8 shows, for example, five types of current-voltage characteristics, with the current-voltage characteristics T100K, T1M, T10M, T100M, and T1G respectively corresponding to the resistance values 100K [Ω], 1M [Ω], 10M [Ω], 100M [Ω], and 1G [Ω] of the emission control variable resistance element 5.

To maintain an emission to non-emission contrast ratio of 1000:1 or higher in the light-emitting element 7, the resistance change ratio of the emission control variable resistance element 5 must be a multiplication factor of about 10000 (100K [Ω] and 1G [Ω]) when an attempt is made to perform control using the emission control variable resistance element 5 only without use of the parallel connection variable resistance element 3. Here, the resistance change ratio indicates the maximum resistance value and minimum resistance value ratio of change of the emission control variable resistance element 5. That is, the emission control variable resistance element 5 requires a performance level in which the resistance change ratio changes in an amount equivalent to four digits or greater.

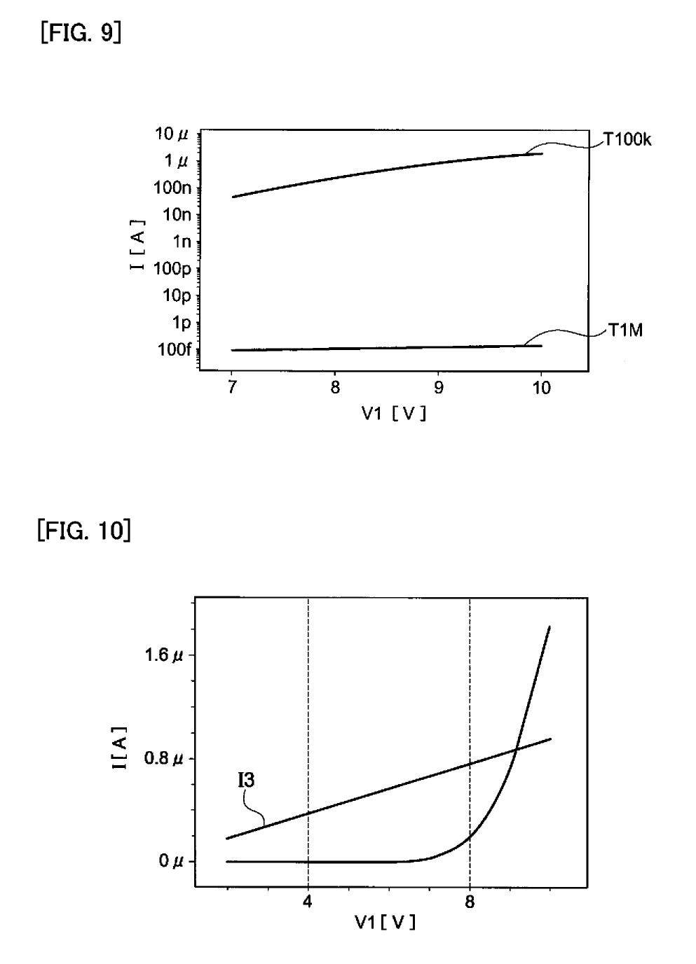

FIG. 9 illustrates an example of current-voltage characteristics for comparing the current that flows on the side of the light-emitting element 7 of the pixel circuit 1 of FIG. 2. That is, the pixel circuit 1 has a configuration in which the above-described parallel connection variable resistance element 3 is connected in parallel to the light-emitting element 7. Note that in FIG. 9 the horizontal axis indicates voltage [V] and the vertical axis indicates current [A].

According to the current-voltage characteristics in the figure, the figure shows a comparison of the current that flows on the side of the light-emitting element 7 in two states: a white writing state (in a case where the resistance value of the emission control variable resistance element 5 is 100 [KΩ] and the resistance value of the parallel connection variable resistance element 3 is 1 [MΩ]) and a black writing state (in a case where the resistance value of the emission control variable resistance element 5 is 1 [MΩ] and the resistance value of the parallel connection variable resistance element 3 is 100 [KΩ]). According to the example in the figure, the voltage of the first power line 11 is indicated on the horizontal axis. The second power line 13 is grounded. The control line 9 is not connected at any location.

According to the current-voltage characteristics shown in the figure, the current ratio is, for example, 100000:1 or higher in the wide-range voltage V1 [V]. That is, given that the ratio of the high resistance state to the low resistance state of the parallel connection variable resistance element 3 and the emission control variable resistance element 5 in the embodiment is about, for example, 100:1, a sufficiently high contrast can be achieved according to the ratio of brightness in the emission state and non-emission state of the light-emitting element 7.

That is, according to the pixel circuit 1 of this embodiment, a difference in the resistance value at the time the emission control variable resistance element 5 is turned ON and the resistance value at the time the emission control variable element 5 is turned OFF is required for controlling the current supplied to the light-emitting element 7. According to the above-described general pixel circuit 1, while the ratio between the resistance value at the time the emission control variable resistance element 5 is turned ON and the resistance value at the time the emission control variable resistance element 5 is turned OFF (hereinafter “ON/OFF resistance ratio”) needs to be approximately 1000:1, the ON/OFF resistance ratio of the emission control variable resistance element 5 does not need to be so large when the pixel circuit 1 uses the configuration shown in FIG. 2 according to the embodiment, allowing a smaller ratio of about 100:1, for example.

The pixel circuit 1 of the above-described embodiment comprises the first power line 11 that supplies a first power, the single control line 9, the emission control variable resistance element 5 having one end connected to the first power line 11 and the other end connected to the control line 9, the second power line 13 that supplies a second power, the light-emitting element 7 that has one end connected to the control line 9 and the other end connected to the second power line 13 and emits light in accordance with the data written to the emission control variable resistance element 5, and the parallel connection variable resistance element 3 having one end connected to the control line 9 and the other end connected to the second power line 13 so that it is parallel with the light-emitting element 7.

The display panel 100 of the above-described embodiment comprises the pixel circuit 1 comprising the first power line 11 that supplies a first power, the single control line 9, the emission control variable resistance element 5 having one end connected to the first power line 11 and the other end connected to the control line 9, the second power line 13 that supplies a second power, the light-emitting element 7 that has one end connected to the control line 9 and the other end connected to the second power line 13 and emits light in accordance with the data written to the emission control variable resistance element 5, and the parallel connection variable resistance element 3 having one end connected to the control line 9 and the other end connected to the second power line 13 so that it is parallel with the light-emitting element 7.

With this arrangement, the pixel circuit 1 can simultaneously change the two variable resistance elements to opposite characteristics using the single control line 1. This pixel circuit 1 has a simple logic design with a low degree of complexity, with just the addition of the control line and parallel connection variable resistance element 3.

When the light-emitting element 7 is to emit light, the pixel circuit 1 changes the emission control variable resistance element 5 to a low resistance state, and the parallel connection variable resistance element 3 to a high resistance state. Then, the current that flows from the first power line 11 via the emission control variable resistance element 5 has difficulty flowing to the parallel connection variable resistance element 3 that is in a high resistance state, but readily flows to the light-emitting element 7. As a result, according to the pixel circuit 1, the light-emitting element 7 is capable of introducing a greater amount of current, making it possible to increase the brightness during emission to a further degree than in prior art.

On the other hand, when the light-emitting element 7 is not to emit light, the pixel circuit 1 changes the emission control variable resistance element 5 to a high resistance state, and the parallel connection variable resistance element 3 to a low resistance state. Then, the slight amount of weak current that flows from the first power line 11 and through the emission control variable resistance element 5 that is in a high resistance state readily flows to the parallel connection variable resistance element 3 that is in a low resistance state rather than to the light-emitting element 7. At this time, the relationship between the resistance values of the light-emitting element 7 and the parallel connection variable resistance element 3 is preferably as follows:

Resistance value of light-emitting element 7 in black-writing state >Resistance value of parallel connection variable resistance element 3 in low resistance state

As a result, according to the pixel circuit 1, the weak current that flows to the light-emitting element 7 during non-emission periods as well can be suppressed, making it possible to decrease the slight amount of emission of the light-emitting element 7 that occurs during non-emission periods as well.

As a result, this pixel circuit 1 is capable of improving the contrast during emission and non-emission of the light-emitting element 7 to a greater extent that prior art. Moreover, in a case where the power supply is stopped and then the light-emitting element 7 is restarted, the pixel circuit 1 can immediately activate the light-emitting element 7 based on the data that remains in the emission control variable resistance element 5, unlike a so-called active matrix drive.

In the pixel circuit 1 of the above-described embodiment, in addition to the above-described configuration, the bias direction in which the light-emitting element 7 emits light and the bias direction in which the parallel connection variable resistance element 3 changes from a low resistance state to a high resistance state is the same direction.

In the display panel 100 of the above-described embodiment, in addition to the above-described configuration, the bias direction in which the light-emitting element 7 emits light and the bias direction in which the parallel connection variable resistance element 3 changes from a low resistance state to a high resistance state is the same direction.

With this arrangement, the timing at which the parallel connection variable resistance element 3 changes from a low resistance state to a high resistance state and the timing at which the light-emitting element 7 emits light are appropriate, making it possible to improve the contrast to a greater extent than prior art when the light-emitting element 7 emits light.

In the pixel circuit 1 of the above-described embodiment, in addition to the above-described configuration, the parallel connection variable resistance element 3 is changed to a high resistance state when the light-emitting element 7 is emitting light.

In the display panel 100 of the above-described embodiment, in addition to the above-described configuration, the parallel connection variable resistance element 3 is changed to a high resistance state when the light-emitting element 7 is emitting light.

With this arrangement, the current that flows through the emission control variable resistance element 5 has difficulty flowing to the parallel connection variable resistance element 3 that is in a high resistance state, but readily flows to the light-emitting element 7. As a result, according to the pixel circuit 1, the light-emitting element 7 is capable of further increasing brightness during emission due to the larger current. Furthermore, according to the pixel circuit 1, it is possible to make the through-current not flow from the emission control variable resistance element 5 to the parallel connection variable resistance element 3.

In the pixel circuit 1 of the above-described embodiment, in addition to the above-described configuration, the light-emitting element 7 is an organic electroluminescent element.

In the display panel 100 of the above-described embodiment, in addition to the above-described configuration, the light-emitting element 7 is an organic electroluminescent element.

With this arrangement, the pixel circuit 1 can be easily manufactured using a general manufacturing process for semiconductor integrated circuits, thereby suppressing manufacturing costs.

In the pixel circuit 1 of the above-described embodiment, in addition to the above-described configuration, the desired control line 9 is set to a potential in a middle of the control voltage range of the first power line 11 and the second power line 13, making the line a non-selected line.

In the display panel 100 of the above-described embodiment, in addition to the above-described configuration, the desired control line 9 of the pixel circuit 1 is set to a potential in a middle of the control voltage range of the first power line 11 and the second power line 13, making the line a non-selected line.

In the pixel circuit 1 of the above-described embodiment, in addition to the above-described configuration, the emission control variable resistance element 5 and the parallel connection variable resistance element 3 are each a two-terminal type variable resistance element.

In the display panel 100 of the above-described embodiment, in addition to the above-described configuration, the emission control variable resistance element 5 and the parallel connection variable resistance element 3 are each a two-terminal type variable resistance element.

With this arrangement, the pixel circuit 1 uses an easy-to-produce and easy-to-manufacture two-terminal type variable resistance element as the emission control variable resistance element 5 and the parallel connection variable resistance element 3, making it possible to use only the single control line 9 even though the parallel connection variable resistance element 3 also exists, thereby simplifying manufacturing and production overall. That is, the pixel circuit 1 does not employ a three-terminal type transistor as the switching element of the light-emitting element 7, thereby simplifying the configuration so that the number of control lines 9 is just one.

Relationship with ON Resistance of Light-Emitting Element During White Writing

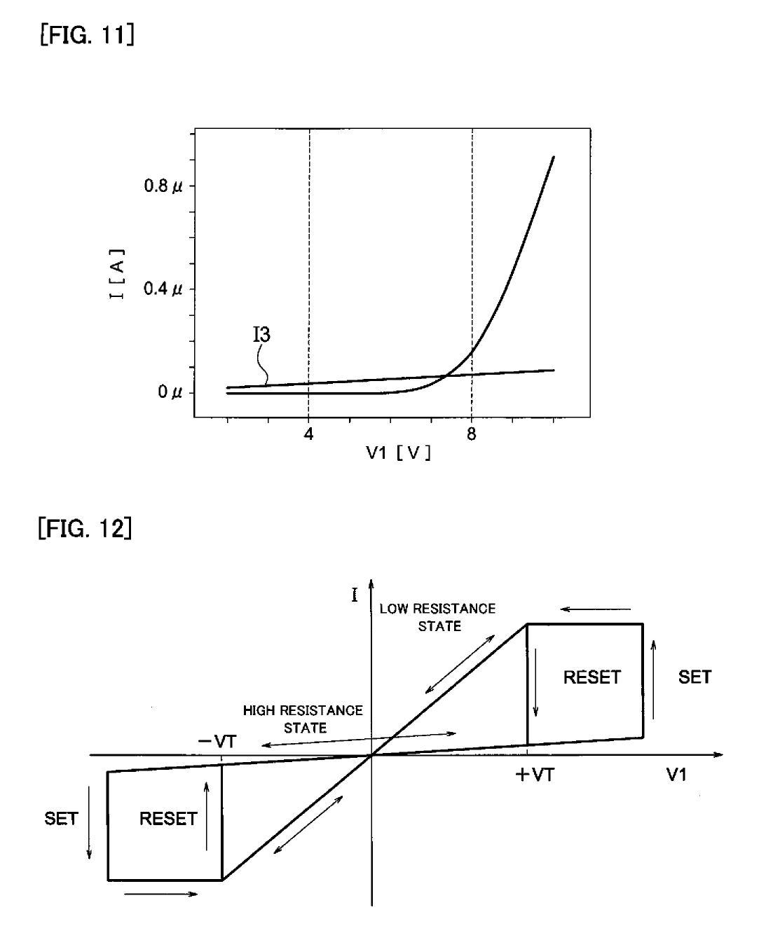

FIG. 10 and FIG. 11 show the current-voltage characteristics of an example of an example of the current that flows to the light-emitting element 7 and the parallel connection variable resistance element 7 connected in parallel to one another. FIG. 10 illustrates a case where the voltage of the control line 9 is controlled so that the resistance value of the emission control variable resistance element 5 is 100 [KΩ], and the resistance value of the parallel connection variable resistance element 3 is 10 [MΩ]. The example illustrates a scenario of light emission, and thus the resistance ratio between the emission control variable resistance element 5 (low resistance state) and the parallel connection variable resistance element 3 (high resistance state) is 1:100.

First, when the light-emitting element 7 is in a light-emitting state, ideally the current flows only to the light-emitting element 7 and not to the parallel connection variable resistance element 3 connected in parallel to the light-emitting element 7.

Nevertheless, when the light-emitting element 7 is in a light-emitting state, as illustrated in FIG. 10, a significant amount of needless current I [A] flows to the parallel connection variable resistance element 3 as well as the light-emitting element 7. This needless current I [A] results in power consumption that does not contribute at all to the light emission performed by the light-emitting current 7. The reason this occurs is presumably that the resistance value of the parallel connection variable resistance element 3 has substantially the same number of digits as the resistance value of the light-emitting element 7. Specifically, when a voltage of about 9.3V is applied from the intersecting point on the graph of FIG. 10 to the light-emitting element, the resistance of the light-emitting element is found to be approximately 10 MΩ as well.

Here, according to the embodiment, suppression of such a useless current I [A] by appropriately adjusting the resistance value of the emission control variable resistance element 5 and the resistance value of the parallel connection variable resistance element 3 is studied.

Specifically, according to the embodiment, the resistance value of the emission control variable resistance element 5 and the resistance value of the parallel connection variable resistance element 3 are both increased ten-fold, thereby making the resistance value of the parallel connection variable resistance element 3 higher than the resistance value of the light-emitting element 7 during light emission. The resistance ratio of 1:100 of the (low resistance state) of the emission control variable resistance element 5 to the (high resistance state) of the parallel connection variable resistance element 3 is maintained as is. According to the embodiment, the voltage of the control line 9 is controlled so that the resistance value of the emission control variable resistance element 5 is 1 [MΩ] and the resistance value of the parallel connection variable resistance element 3 is 100 [MΩ]. Then, the needless current I [A] that flows to the parallel connection variable resistance element 3 when the light-emitting element 7 is in a light-emitting state lowers dramatically, as illustrated in FIG. 11, suppressing needless power consumption. Furthermore, since the resistance value of the emission control variable resistance element 5 is 1 [MΩ], it is understood that the emission control variable resistance element 5 is sufficiently lower than the resistance value (approximately 10 MΩ at 9.3 V) of the light-emitting element 7, thereby lowering the power consumption of the emission control variable resistance element 5. That is, the resistance value size correlation is preferably as follows:

Resistance value of emission control variable resistance element 5 in a low resistance state <Resistance value of light-emitting element 7 during white writing <Resistance value of parallel connection variable resistance element 5 in high resistance state

With this arrangement, the slight amount of current that flows to the parallel connection variable resistance element 3 when the light-emitting element 7 is emitting light is further decreased, thereby decreasing the drop in voltage of the emission control variable resistance element 5, making it possible to suppress power consumption in general.

In the pixel circuit 1 of the above-described embodiment, in addition to the above-described embodiment, the states of resistance of the emission control variable resistance element 5 and the parallel connection variable resistance element 3 change when the voltage difference is greater than the voltage difference exerted against the light-emitting element 7 during light emission.

In the display panel 100 of the above-described embodiment, in addition to the above-described embodiment, the states of resistance of the emission control variable resistance element 5 and the parallel connection variable resistance element 3 in the pixel circuit 1 change when the voltage difference is greater than the voltage difference exerted against the light-emitting element 7 during light emission.

With this arrangement, the flow of needless current is suppressed, making it possible to suppress needless power consumption in general.

According to the pixel circuit 1 of the above-described embodiment, in addition to the configuration described above, the emission control variable resistance element 5 and the parallel connection variable resistance element 3 have a high resistance state to low resistance state resistance ratio greater than a multiplication factor of 10 and less than a multiplication factor of 1000.

In the display panel 100 of the above-described embodiment, in addition to the configuration described above, the emission control variable resistance element 5 and the parallel connection variable resistance element 3 of the pixel circuit 1 have a high resistance state to low resistance state resistance ratio greater than a multiplication factor of 10 and less than a multiplication factor of 1000.

With this arrangement, the flow of needless current is suppressed, making it possible to suppress needless power consumption in general.

In the pixel circuit 1 of the above-described embodiment, in addition to the above-described configuration, the resistance value of the parallel connection variable resistance element 3 is smaller than the resistance value of the light-emitting element 7 when control for not emitting light is performed.

In the display panel 100 of the above-described embodiment, in addition to the above-described configuration, the resistance value of the parallel connection variable resistance element 3 in the pixel circuit 1 is smaller than the resistance value of the light-emitting element 7 when control for not emitting light is performed.

With this arrangement, the flow of needless current is suppressed, making it possible to suppress needless power consumption in general.

In the pixel circuit 1 of the above-described embodiment, in addition to the above-described configuration, the resistance value of the light-emitting element 7 is smaller than the resistance value of the parallel connection variable resistance element 3 and greater than the resistance value of the emission control variable resistance element 5 when control for emitting light is performed.

In the display panel 100 of the above-described embodiment, in addition to the above-described configuration, the resistance value of the light-emitting element 7 of the pixel circuit 1 is smaller than the resistance value of the parallel connection variable resistance element 3 and greater than the resistance value of the emission control variable resistance element 5 when control for emitting light is performed.

With this arrangement, the flow of needless current is suppressed, making it possible to suppress needless power consumption in general.

### Other Embodiments

FIG. 12 shows hysteresis loop characteristics illustrating an example of the current-voltage characteristics corresponding to the state of the parallel connection variable resistance element 3 of the pixel circuit of another embodiment. Note that the hysteresis loop characteristics in the figure are substantially the same as the hysteresis loop characteristics of FIG. 3 described above, and thus the descriptions thereof will be omitted, and the following will focus on the differences between the embodiments.

According to this other embodiment, the parallel connection variable resistance element 3 of the pixel circuit 1 is a non-polar type, for example. Note that the other components of the pixel circuit 1 of this other embodiment are the same as those of the previous embodiment, and descriptions thereof will be omitted.

According to the pixel circuit 1 of this other embodiment, SET and RESET are determined in accordance with the size of the absolute value of the bias voltage, unlike the pixel circuit 1 of the above embodiment.

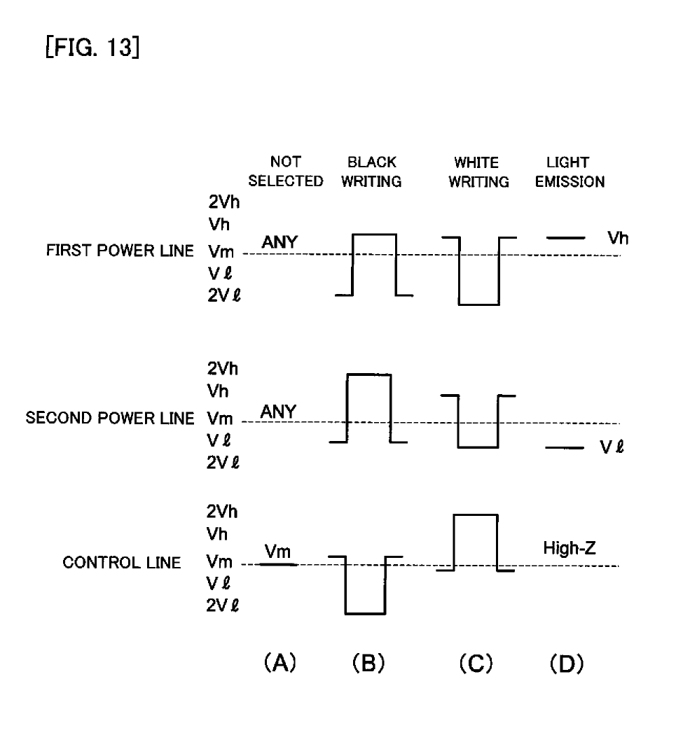

FIG. 13A to FIG. 13D each illustrate an example of voltage control of each signal line for data writing. Note that the voltage control examples in the figures are substantially the same as the voltage control examples of FIG. 5A to FIG. 5D above, and thus descriptions of substantially identical sections will be omitted, and the following will focus on the differences.

The emission control variable resistance element 5 oscillates the difference in potential produced between the first power line 11 and the control line 9 as illustrated in FIG. 13B or FIG. 13C, resulting in data writing (black writing or white writing). On the other hand, the parallel connection variable resistance element 3 also oscillates the difference in potential produced between the second power line 13 and the control line 9 as illustrated in FIG. 13B or FIG. 13C, resulting in data writing (black writing or white writing).

According to the pixel circuit 1 of such an embodiment, the operation performed can be the same as the above embodiment if the voltage setting is set so that there is no change in the data storage contents of the emission control variable resistance element 5 and the parallel connection variable resistance element 3 during emission of the light-emitting element 7.

Note that the embodiments of the present invention are not limited to the above, and various modifications are possible. In the following, details of such modifications will be described one by one.

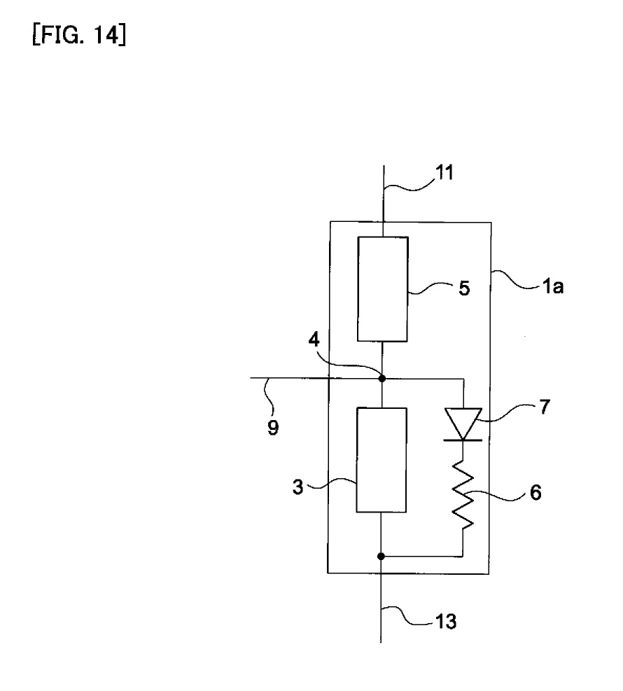

FIG. 14 is an equivalent circuit diagram illustrating a configuration example of a pixel circuit la of a modification of each embodiment. Note that the pixel circuit la of FIG. 14 has substantially the same components as the pixel circuit of the FIG. 2 described above. Thus, the descriptions of identical components and operations will be omitted, and the following will focus on the differences.

The pixel circuit la of the above embodiment, in addition to the configuration of each of the above-described pixel circuits 1, further comprises an overcurrent prevention resistor 6 that is connected in series to the light-emitting element 7 between the control line 9 and the second power line 13.

A display panel 100a of the above embodiment, in addition to the configuration of each of the above-described display panels 100, further comprises an overcurrent prevention resistor 6 that is connected in series to the light-emitting element 7 between the control line 9 and the second power line 13.

With this arrangement, assuming that overcurrent flows to the light-emitting element 7, the existence of the overcurrent prevention resistor 6 connected in series to the light-emitting element 7 makes it possible to prevent the flow of overcurrent to the light-emitting element 7 itself and, in turn, prevent the breakdown of the light-emitting element 7.

1. A pixel circuit comprising:
a first power line that supplies a first power;
a single control line;
an emission control variable resistance element having one end connected to said first power line and another end connected to said control line;
a second power line that supplies a second power;
a light-emitting element having one end connected to said control line and another end connected to said second power line, that emits light in accordance with data written to said emission control variable resistance element; and
a parallel connection variable resistance element having one end connected to said control line and another end connected to said second power line so that it is parallel with said light-emitting element.

2. The pixel circuit according to claim 1, wherein:
a bias direction in which said light-emitting element emits light and a bias direction in which said parallel connection variable resistance element changes from a low resistance state to a high resistance state is the same direction.

3. The pixel circuit according to claim 1, wherein:
said parallel connection variable resistance element is in a high resistance state when said light-emitting element is emitting light.

4. The pixel circuit according to claim 1, further comprising:
an overcurrent prevention resistor that is connected in series to said light-emitting element between said control line and said second power line.

5. The pixel circuit according to claim 1, wherein:
a desired said control line is set to a potential in a middle of a control voltage range of said first power line and said second power line so that it becomes a non-selected line.

6. The pixel circuit according to claim 1, wherein:
said emission control variable resistance element and said parallel connection variable resistance element are each a two-terminal type variable resistance element.

7. The pixel circuit according to claim 6, wherein:
the resistance states of said emission control variable resistance element and said parallel connection variable resistance element change when the voltage difference is larger than the voltage difference exerted against said light-emitting element during light emission.

8. The pixel circuit according to claim 1, wherein:
said emission control variable resistance element and said parallel connection variable resistance element have a resistance value ratio of a high resistance state to a low resistance state that is greater than a multiplication factor of 10 and less than a multiplication factor of 1000.

9. The pixel circuit according to claim 1, wherein:
the resistance value of said parallel connection variable resistance element is smaller than the resistance value of said light-emitting element when control for not emitting light is performed.

10. The pixel circuit according to claim 1, wherein:
the resistance value of said light-emitting element is smaller than the resistance value of said parallel connection variable resistance element and larger than the resistance value of said emission control variable resistance element when control for emitting light is performed.

11. The pixel circuit according to claim 1, wherein:
said light-emitting element is an organic electroluminescent element.

12. A display panel arranging at least a pixel circuit, said pixel circuit comprising:
a first power line that supplies a first power;
a single control line;
an emission control variable resistance element having one end connected to said first power line and another end connected to said control line;
a second power line that supplies a second power;
a light-emitting element having one end connected to said control line and another end connected to said second power line, that emits light in accordance with data written to said emission control variable resistance element; and
a parallel connection variable resistance element having one end connected to said control line and another end connected to said second power line so that it is parallel with said light-emitting element.

13. The pixel circuit according to claim 2, wherein:
said parallel connection variable resistance element is in a high resistance state when said light-emitting element is emitting light.

14. The pixel circuit according to claim 2, further comprising:
an overcurrent prevention resistor that is connected in series to said light-emitting element between said control line and said second power line.

15. The pixel circuit according to claim 2, wherein:
a desired said control line is set to a potential in a middle of a control voltage range of said first power line and said second power line so that it becomes a non-selected line.

16. The pixel circuit according to claim 2, wherein:
said emission control variable resistance element and said parallel connection variable resistance element are each a two-terminal type variable resistance element.

17. The pixel circuit according to claim 2, wherein:
said emission control variable resistance element and said parallel connection variable resistance element have a resistance value ratio of a high resistance state to a low resistance state that is greater than a multiplication factor of 10 and less than a multiplication factor of 1000.

18. The pixel circuit according to claim 2, wherein:
the resistance value of said parallel connection variable resistance element is smaller than the resistance value of said light-emitting element when control for not emitting light is performed.

19. The pixel circuit according to claim 2, wherein:
the resistance value of said light-emitting element is smaller than the resistance value of said parallel connection variable resistance element and larger than the resistance value of said emission control variable resistance element when control for emitting light is performed.

20. The pixel circuit according to claim 2, wherein:
said light-emitting element is an organic electroluminescent element.
